(19) United States
(12) Patent Application Publication
(10) Pub. No.: US 2023/0327893 A1
(43) Pub. Date: Oct. 12, 2023

(54) SECURELY CREATING A NONFUNGIBLE TOKEN ON A BLOCK CHAIN USING A 5G INFRASTRUCTURE OF A WIRELESS TELECOMMUNICATION NETWORK

(71) Applicant: T-Mobile USA, Inc., Bellevue, WA (US)

(72) Inventors: Lyle Walter Paczkowski, Mission Hills, KS (US); Galip Murat Karabulut, Vienna, VA (US); Oliver P. Coudert, Reston, VA (US)

(21) Appl. No.: 17/719,184

(22) Filed: Apr. 12, 2022

(51) Int. Cl. H04L 9/00; H04W 12/30; H04W 12/06; G06F 21/74; H04W 12/63; G06Q 20/40; G06Q 30/08

(52) U.S. Cl. CPC H04L 9/50; H04W 12/35; H04W 12/06; G06F 21/74; H04W 12/63; G06Q 20/401; G06Q 30/08; H04L 2209/80; H04L 2209/56

(57) ABSTRACT

Disclosed here is a system to receive an input from a user, indicating a request to create a recording and an NFT from the recording. The system can operate in a rich environment mode, and a hardware root of trust mode that verifies a software running in the hardware root of trust mode using cryptographic keys. The system switches the operation into a hardware root of trust mode. The system sends to a server a request to create the NFT, including multiple authentication factors. The server authenticates the request based on the multiple authentication factors and determines an entity having an interest in the NFT. The system receives a permission to make the recording and an indication of the entity having the interest in the NFT, makes the recording, and causes creation of the NFT.

### BACKGROUND

A nonfungible token (NFT) is a unit of data stored, for example, on a block chain which is a form of digital ledger. NFTs can be sold and traded. Types of NFT data units may be associated with digital files such as photos, videos, and audio. Because each token is uniquely identifiable, NFTs differ from block chain cryptocurrencies, such as bitcoin. NFT ledgers claim to provide a public certificate of authenticity or proof of ownership, but the legal rights conveyed by an NFT can be uncertain. NFTs do not restrict the sharing or copying of the underlying digital files, do not necessarily convey the copyright of the digital files, and do not prevent the creation of NFTs with identical associated files.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 shows a system to securely create a nonfungible token (NFT) on a block chain using a 5G infrastructure of a wireless telecommunication network.

FIG. 4 shows indexing of the NFT across multiple ledgers and user authentication.

FIG. 5 is a flowchart of a method to securely create an NFT on a block chain using a 5G infrastructure of a wireless telecommunication network, according to one embodiment.

FIG. 6 is a flowchart of a method to securely create an NFT on a block chain using a 5G infrastructure of a wireless telecommunication network, according to another embodiment.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Disclosed here is a system and method to securely create an NFT on a block chain using a 5G infrastructure of a wireless telecommunication network. The system can receive a request to create an NFT from a mobile device associated with a user, where the request is generated by a software operating on the mobile device in a secure protected boot mode. The secure protected boot mode operates in a hardware root of trust mode and ensures integrity of the software using a cryptographic key. Secure protected boot is a mechanism in which authenticity and integrity of the software is checked during the booting phase by using the chain of trust mechanism. In computer security, a chain of trust is established by validating each component of hardware and software from the end entity up to the root certificate. It is intended to ensure that only trusted software and hardware can be used while still retaining flexibility. It starts with hardware that will only boot from software that is digitally signed using the recognized cryptographic key. The signing authority will only sign boot programs that enforce security, such as only running programs that are themselves signed, or only allowing signed code to have access to certain features of the machine. This process may continue for several layers.

The present system can obtain from the software operating on the mobile device in the secure protected modes, multiple authentication factors including a location associated with the mobile device, a time associated with the request, a code indicating an activity occurring at the location at the time, an identifier (ID) associated with the mobile device, and an ID associated with the user. The code indicating the activity can include a barcode, a quick response (QR) code, and/or a digital certificate. Based on the multiple authentication factors, the system can determine an entity having an interest in the activity occurring at the location at the time. The interest can include copyright ownership.

The system can search the block chain to determine whether the block chain includes an authorization to record the activity occurring at the location at the time, where the authorization is granted by the entity to a user of the mobile device, or to the mobile device. Upon determining that the block chain includes the authorization to record the activity occurring at the location at the time, the system can receive from the software operating on the mobile device a recording associated with the activity occurring at the location at the time. The recording can be an image, a video, or an audio. Upon determining that the block chain includes the authorization to record the activity occurring at the location at the time, the system can create a block in the block chain including the multiple authentication factors, the authorization to record the activity occurring at the location at the time, and the recording.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

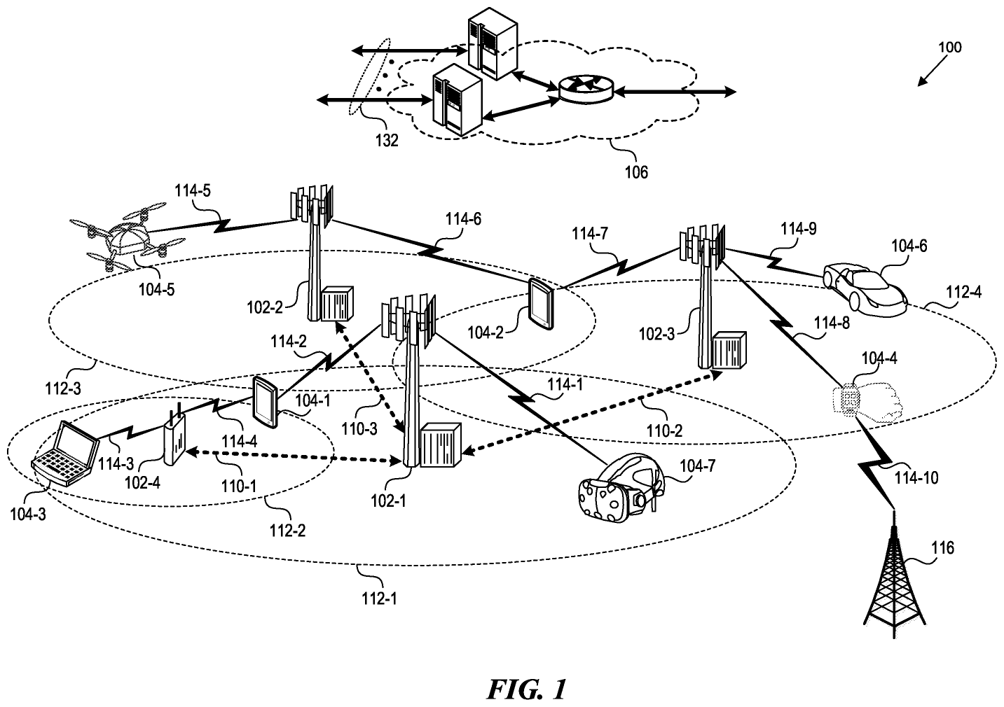

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet-of-Things (IoT), mobile broadband (MBB), vehicle-to-everything (V2X), machine-to- machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNBs is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the system 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 can include LTE, 5G or communications technologies at frequencies that can include mmW.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

### 5G Core Network Functions

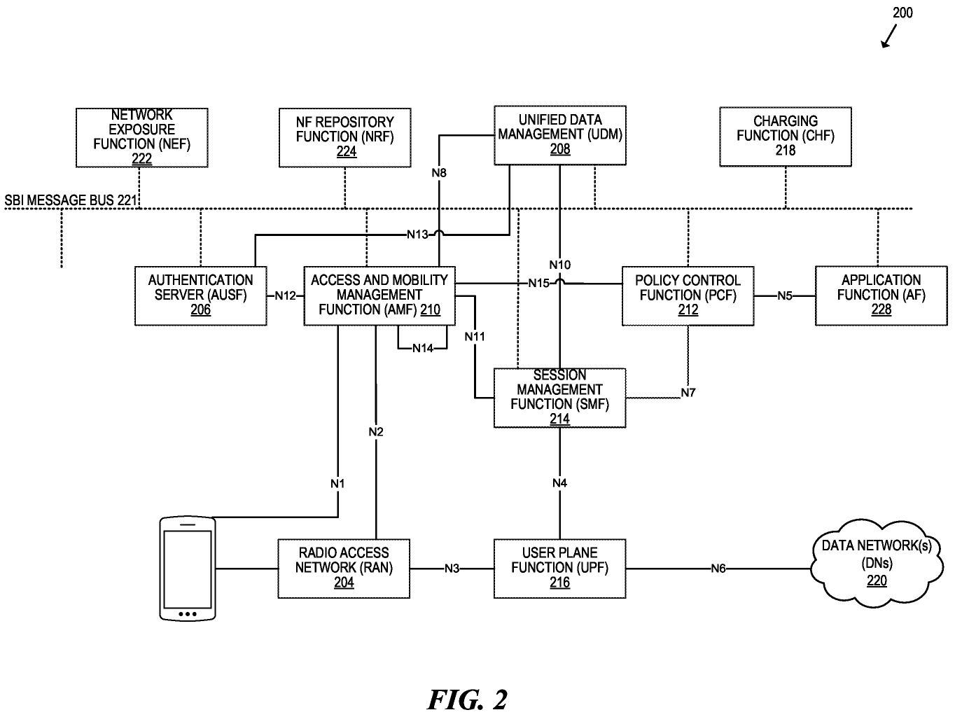

FIG. 2 is a block diagram that illustrates an architecture 200 including 5G core network functions (NFs) that can implement aspects of the present technology. A wireless device 202 can access the 5G network through a NAN (e.g., gNB) of a Radio Access Network (RAN) 204. The NFs include an Authentication Server Function (AUSF) 206, a Unified Data Management (UDM) 208, an Access and Mobility Management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements, and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS), serving to provide authentication credentials while being employed by the AMF 210 and SMF 214 to retrieve subscriber data and context.

The PCF 212 can connect with one or more application functions (AFs) 228. The PCF 212 supports a unified policy framework within the 5G infrastructure for governing network behavior. The PCF 212 accesses the subscription information required to make policy decisions from the UDM 208, and then provides the appropriate policy rules to the control plane functions so that they can enforce them. The SCP (not shown) provides a highly distributed multi-access edge compute cloud environment and a single point of entry for a cluster of network functions, once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224, use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework which, along with the more typical quality of service and charging rules, includes network slice selection, which is regulated by the NSSF 226.

### Securely Creating a Nonfungible Token on a Block Chain Using a 5G Infrastructure of a Wireless Telecommunication Network

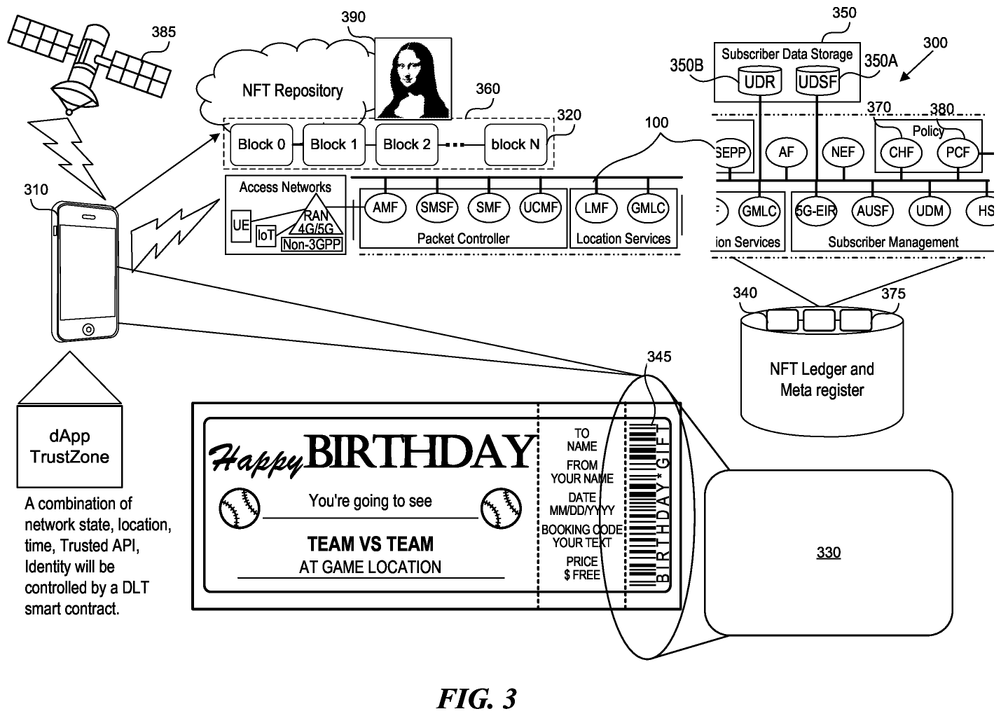

FIG. 3 shows a system to securely create an NFT on a block chain using a 5G infrastructure of a wireless telecommunication network. For example, a user carrying a UE 310 can be at an event organized by another entity. The event can be a Major League Baseball (MLB) game or ticketed artistic event, such as a gallery opening or a concert. The user may want to take a recording 390, such as video, an image, or an audio, of the event and publish the recording as an “art asset” using an NFT 320. The action can violate rules of copyright of the entity organizing the event, such as MLB, or the theatre, unless the entity agrees to the creation of the NFT 320.

The system 300 can enable the user to create the NFT 320 with the agreement of the entity 330 organizing the event. The system 300 can establish a trusted process that combines a network 100 authentication process, smart contracts, an NFT, and a decentralized application (dApp) programming sequence. A dApp is an application built on a decentralized network that combines a smart contract and a front-end user interface.

The UE 310 can request authority to create the NFT 320. Before granting the authority to create the NFT 320, the network 100 needs to verify that the user has permission to create the NFT. The network 100 can be a 5G or a higher generation network. The network 100 can include a satellite 385. To determine whether the user has permission, the network 100 can gather information about the activity to be recorded. Based on the activity to be recorded, the network 100 can determine whether another entity 330 has an interest in the recording 390, such as a copyright. If no other entity has an interest in the recording 390, the network 100 can grant authority to the UE 310 to create the NFT 320. If another entity 330 has an interest in the recording 390, the network 100 can determine whether the other entity 330 has agreed to creation of the NFT 320. If the other entity 330 has agreed to the creation of the recording 390, the network 100 can grant the authority to the UE 310 to create the NFT 320.

To determine the activity to be recorded, the network 100 can receive from the UE 310 authentication factors including information about the network state, the location of the UE 310, the current time, an identifier (ID) of the UE 310, an ID of the user of the UE 310, and a code 345 associated with the activity. The code 345 can be a QR code, bar code, digital certificate granted at the time of purchase, etc. The code 345 can include radiofrequency identification, near field communication radio systems, and other personal or network standard radiofrequency transmission. The code can include latitude and longitude coordinates and a radius to define the geographical area. For example, the geographical center of Disney World can be provided, along with a radius of 4.5 miles. A calculation can be made using the UE GPS coordinates to help validate that the UE is in the area of interest.

Information about the network state can include an ID of the network to which the UE 310 is connected, such as an ID of the Wi-Fi network to which the UE is connected. The Wi-Fi network can belong to the entity 330, thus aiding the identification of the activity. The UE 310 can scan the barcode 345 prior to sending the request to create the NFT 320, and can store the barcode to send along with the request to create to the NFT. Alternatively, the UE 310 can scan the barcode 345 and immediately send the barcode to the network 100. Based on the authentication factors, such as the location, the current time, and/or the barcode 345, the network 100 can determine that the user is at a baseball stadium at the time when a baseball game is going on, and that the user wants to create a recording at the baseball stadium.

To ensure that the UE 310 is sending truthful information and the UE 310 or the software running on the UE 310 has not been tampered with, the UE 310 needs to operate in the hardware root of trust mode. A hardware root of trust is the foundation on which all secure operations of a computing system depend. Hardware root of trust contains the keys used for cryptographic functions and enables a secure boot process. For example, prior to boot in the hardware root of trust mode, the operating system provides a cryptographic key to the UE 310 for the UE to identify the operating system. Further, any software that runs in the hardware root of trust mode needs to provide a unique cryptographic key for the UE 310 to identify the operating system. The cryptographic keys so used can be a hash of the computer code, so any changes to the computer code change the cryptographic key, therefore indicating any tampering with the computer code.

The UE 310 generally operates in a rich environment, which does not require cryptographic keys to operate. In the rich environment, multiple applications can run without supplying any kind of cryptographic key to the UE. To switch to the hardware root of trust mode, the UE 310 can store a copy of the memory and all the registers of the UE, and hibernate the rich environment . . . The UE 310 can boot the operating system in the hardware root of trust mode and start the software in the hardware root of trust mode. The software can request the creation of the NFT 320, authenticate the UE 310 and/or the user of the UE 310, and make the recording 390 of the activity. Sensor data from trusted UE cameras, microphones, vibration sensors, and accelerometers, gathered in combination add to the complexity and veracity of the ID of the device and the user.

Once the software operating in the hardware root of trust mode completes the communication with the network 100, the UE 310 can exit the hardware root of trust mode, and reinstate the rich environment. Completion of the communication with the network 100 can occur once the network 100 denies the request to create the NFT 320, or once the software provides an indication that the recording 390 of the activity is complete, such as an indication to create an end-of-life block in a block chain including the NFT.

Based on the baseball game, the network 100 can determine the entity 330 having an interest in the baseball game. The entity 330 can be the sponsor of the baseball game, the stadium owner, and/or the baseball teams participating. The entity 330 can include multiple entities.

Once the network 100 determines the entity 330 having an interest in the activity, the network can determine whether the entity has authorized the UE 310 to make the recording 390. The network 100 can make the determination by searching the block chain 340 to find a contract between the entity 330 and the UE 310 and/or the user of the UE 310. The contract can indicate that the entity 330 authorizes all visitors to the activity to make a recording 390.

Once the network 100 authorizes the UE 310 to make the recording 390, the authorization can be registered in the Subscriber Data Storage elements 350, namely, Unified Data Repository (UDR) 350A, Unstructured Data Storage Function (UDSF) 350B. UDR is a converged repository, which is used by 5G network functions to store the data. UDSF offers storage of unstructured context and state information to all core network functions across the service-based architecture.

To create the NFT 320, the network 100 can create blocks 0, 1, 2, N. Block 0 can be the genesis block of the NFT 320. Block 1 can hold the authentication factors used to grant the permission to create the NFT 320, the ID of the entity 330, and the ID of the contract authorizing the creation of the NFT. Block 2 can be the beginning of the NFT content. Block N can be an end-of-life block as explained in this application. The block chain 360 including the blocks 0, 1, 2, N can be a stand-alone block chain defining the NFT 320, or can be part of the block chain 340. The block chain 360 can be stored in the CHF 370 and PCF 380 of the network 100. The PCF 380 helps operators to easily create and seamlessly deploy policies in a 5G network. In addition, the UE 310 can store the block chain 360.

The information contained in the block chain 360 can be audited to ensure that the information gathered by the NFT 320 is truthful and is authorized. In other words, the information contained in the block chain 360 can be audited to prove its provenance. Specifically, the authentication factors stored in block 1 are generated using a hardware root of trust and stored in the block chain 360, which is immutable. The smart contract authorizing the recording 390 contained in the NFT 320 is also stored in the immutable block chain 340. In addition, the content associated with the NFT 320 is stored in the immutable block chain 360. Having information authorizing the creation of the NFT 320 gathered from secure sources, e.g., the hardware root of trust, and storing the NFT 320 content in an immutable block chain 360, guarantees the truthfulness of the information in the block chain 360.

The network 100 can retrieve from the block chain 340 a block 375 that indicates how interest in the NFT 320 is split up between the entity 330 and the user. The interest can be the ownership of the NFT 320, or the division of funds received in a transaction involving the NFT 320, such as transfer of ownership. Based on the division of interest, the network 100 can distribute the funds to the user and the entity 330.

To facilitate a transfer of ownership of the NFT 320, the network 100 can organize an automatic auction. The network 100 can advertise the time and place of the auction to multiple UEs, and can receive bidding rules from the various UEs. For example, a bidding rule can state that if somebody bids up to $10,000 more than the user, then that bid should be outbid by a certain amount, such as $10,000, until the user's auction price hits a predetermined ceiling, such as $100,000.

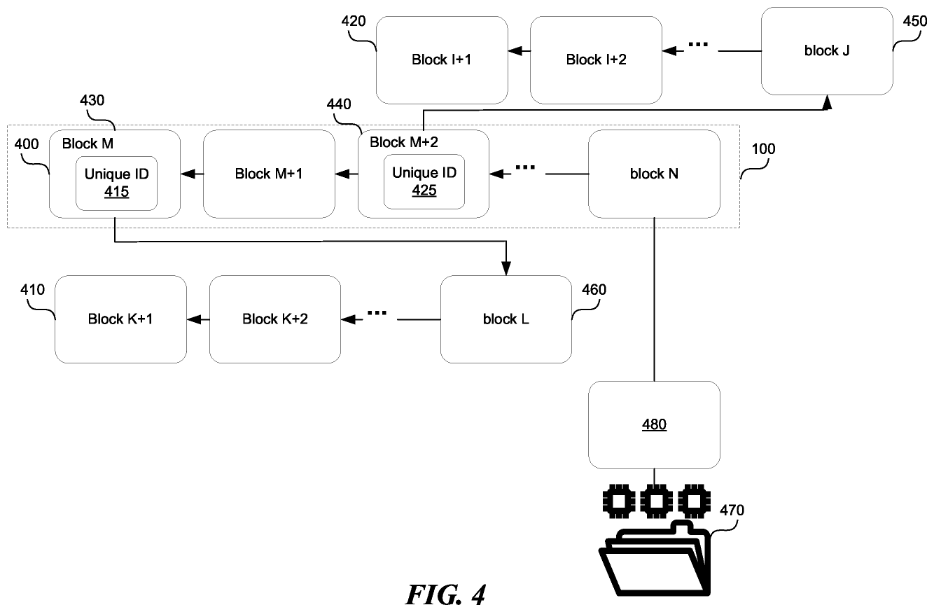

The UE 310 can request from the network 100 access to the block chain 340, 360. The access can request creation of the NFT 320, or request to perform an operation on the NFT, such as transfer of at least a portion of the interest in the NFT. The network 100 needs to authorize the UE 310 before allowing access to the NFT 320 by establishing access to the NFT within the 5G service architecture. To authorize the UE 310, the network 100 can request a unique ID, e.g., 415, 425 in FIG. 4, identifying the NFT 320, information specifying the transaction, and unique ID of all the participants in the transaction. Each participant can be a user, and/or an entity 330. If the entity 330 is a part of a large network, such as a large delivery distribution network, the entity 330 can specify the entity's ID within the network. For example, the large delivery distribution network has wholesalers, retailers, logistics companies, and transport companies. The entity 330 can be the transport company and can identify itself with an ID “large delivery distribution network→transportation→[company].”

To authenticate the user, the network 100 can verify that the unique ID of the NFT 320 is valid, and that the participants involved in the transaction have an interest in the NFT. Once the ID of participants and the NFT 320 have been confirmed, the network 100 can ask the participants to authenticate themselves by, for example, using a password. In addition, the network 100 can require the participants to identify themselves using the participant ID and a UE 310 ID. For example, the network 100 can store a list of devices associated with a particular user, and can allow the user to interact with the network only from those devices. Requiring the ID of the user and the ID of the UE 310 to match the information stored in the network 100 increases the security of the network, and prevents unauthorized users logging in from stolen devices, or the user logging in from an unauthorized device.

FIG. 4 shows indexing of the NFT across multiple ledgers and user authentication. The network 100 can include a block chain, e.g., reference chain 400. Unlike bitcoin, the block chains 340, 360 in FIG. 3 and reference chain 400 in FIG. 4 can create consensus in the block chain using a low carbon footprint method, such as gossip or rumor methods, without using proof of work. The block chains 340, 360, 400 are immutable, and once a block is recorded, it cannot be changed.

The reference chain 400 can be a meta-collection that includes references to other block chains 410, 420 that can be stored within the network 100, or on other wireless telecommunication networks, or other block chain networks. The block chains 410, 420 can represent NFTs. The reference chain 400 can include a unique ID, e.g., an index, 415, 425 associated with each NFT 410, 420, respectively. For example, each block 430, 440 in the reference chain 400 can include a pointer to the other block chains 410, 420. Each block 430, 440 can point to the end-of-life block 450, 460 associated with each NFT 410, 420, respectively.

The end-of-life block 450, 460 can indicate a termination of the recording of the NFT 410, 420. The end-of-life block 450, 460 can point to the previous block. Backwards traversal of the NFT 410, 420 from the end-of-life block 450, 460 enables traversal of the whole NFT. The unique ID can be computed based on contents of the last block, such as a cryptographic hash.

Once the network 100 authorizes the UE 310 in FIG. 3 to access the NFT 320 in FIG. 3 or the NFT 410, 420 in FIG. 4, the network allows the UE to read the end-of-life block N in FIG. 3 or the end-of-life block 450, 460 in FIG. 4. The UE 310 can receive either the direct pointer to the archived file, as explained below, or the block, on the block chain 340, 360, 410, 420, tracking archived files.

The network 100 can aggregate and archive the data 480 on the block chain 340, 360, 410, 420 into archivable files. The network 100 can store the archived data 480 in a database operating under a hardware root of trust, so that the chain of custody or provenance of the NFT 320, 410, 420 can be assured from creation to retrieval.

The archived data 480 and/or the NFT 320, 410, 420 can be stored in an interplanetary file system (IPFS) 470 because IPFS is a reliable method to disperse large data shares in a secure fashion. The IPFS 470 is a protocol and peer-to-peer network for storing and sharing data in a distributed file system. The IPFS 470 uses content-addressing to uniquely identify each file in a global namespace connecting all computing devices.

Content-addressable storage (CAS) is a way to store information so that it can be retrieved based on its content, not its location. CAS typically uses a cryptographic hash function's digest generated from the document to identify that document in the storage system. When information is stored into a CAS system, the system will record a content address, which is an identifier uniquely and permanently linked to the information content itself. A request to retrieve information from a CAS system must provide the content identifier, from which the system can determine the physical location of the data and retrieve it. Because the identifiers are based on content, any change to a data element will necessarily change its content address. In nearly all cases, a CAS device will not permit editing information once it has been stored. Because the NFTs 320, 410, 420 stored in the block chain are immutable, CAS is an effective way to store their locations.

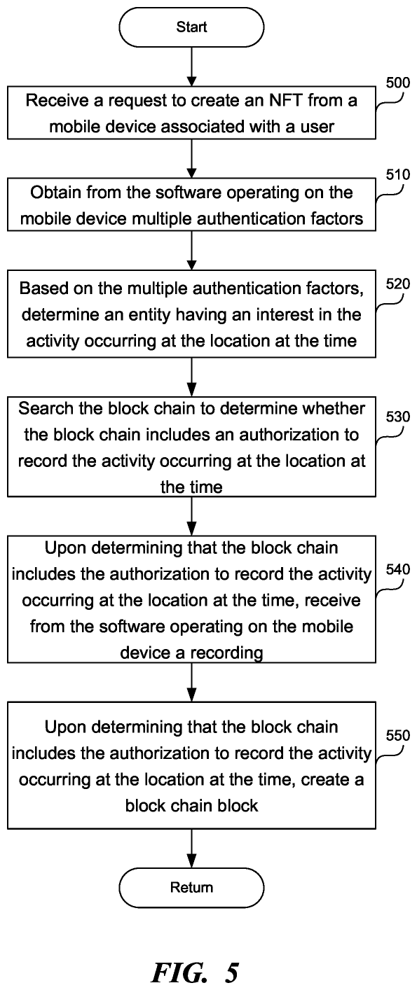

FIG. 5 is a flowchart of a method to securely create an NFT on a block chain using a 5G infrastructure of a wireless telecommunication network, according to one embodiment. A hardware or software processor performing instructions described in this application, in step 500, can receive a request to create an NFT from a UE associated with a user. The request can be generated by a software operating on the UE in a secure protected boot mode. The secure protected boot mode ensures integrity of the software using a cryptographic key and can operate in a hardware root of trust mode. Protected boot is a security control used to ensure authentic software is executed on the microcontroller. Protected boot is a mechanism through which authenticity and integrity of the software is checked during the booting phase by using the chain of trust mechanism. Protected boot can be achieved by using an authenticated boot or a secure boot mechanism. Integrity of the software is ensured by using symmetric and asymmetric crypto algorithms. Protected boot is executed using sequential or parallel execution mode.

In step 510, the processor can obtain from the software operating on the UE multiple authentication factors including a location associated with the UE, a time associated with the request, a code indicating an activity occurring at the location at the time, an identifier (ID) associated with the UE, and an ID associated with the user. The ID of the UE and/or of the user can be included in a specialized integrated circuit (IC) that has critical, immutable, sovereign, or distributed IDs within. The IC can be integrated with the UE, with an accessory associated with the user, and/or implanted within the user device. The code 345 can include a barcode, a QR code, and/or a digital certificate. The software operates in the secure protected boot mode to ensure authenticity of the gathered data.

In step 520, based on the multiple authentication factors, the processor can determine an entity having an interest in the activity occurring at the location at the time. The entity can be an organizer of the activity, a sponsor of the activity, a participant in the activity, etc.

In step 530, the processor can search the block chain to determine whether the block chain includes an authorization to record the activity occurring at the location at the time. The authorization can be stored as a smart contract in the block chain. The entity can grant the authorization to the UE and/or to the user making the recording.

In step 540, upon determining that the block chain includes the authorization to record the activity occurring at the location at the time, the processor can receive from the software operating on the UE a recording associated with the activity occurring at the location at the time. The recording can be an image, a video, an audio, or another form of multimedia presentation.

In step 550, upon determining that the block chain includes the authorization to record the activity occurring at the location at the time, the processor can create a block chain block including the multiple authentication factors, the authorization to record the activity occurring at the location at the time, and the recording.

The processor can share revenue upon transaction associated with the NFT using smart contracts embedded in the NFT and associated ledger system. Upon determining that the block chain includes the authorization to record the activity occurring at the location at the time, the processor can retrieve from the block chain a first indication of interest associated with the entity in the recording and a second indication of interest associated with the user in the recording. The processor can receive an indication of a transfer of funds associated with the recording from a third party to the user. The processor can distribute the funds to the user and the entity based on the first indication of interest and the second indication of interest. The first and the second indication of interest can include percentage of NFT ownership.

The processor can organize automatic auctions for the NFT. Upon determining that the block chain includes the authorization to record the activity occurring at the location at the time, the processor can retrieve from the block chain a first indication of interest associated with the entity in the recording and a second indication of interest associated with the user in the recording. The processor can distribute information about an auction associated with the NFT to multiple UEs. The information can include an identifier (ID) associated with the NFT, a time, and a location, such as an Internet protocol (IP) address. The processor can receive multiple bids for the NFT from multiple parties. The processor can determine a highest bid among the multiple bids, where the highest bid is associated with a first party among the multiple parties. The processor can transfer the interest in the NFT to the first party among the multiple parties. The processor can distribute the highest bid to the entity and the user based on the first indication of interest and second indication of interest.

The processor can establish the indexing protocol, e.g., unique ID associated with the NFT, and location of the NFT along with authentication and access rights. The NFT can be stored in an IPFS, which is indexed by immutable NFT content, and not by memory location of the NFT. The processor can create a unique identifier corresponding to the NFT. The processor can obtain multiple block chains. The processor can search the multiple block chains for a block associated with the NFT. The block chains can be defined and/or stored on other wireless telecommunication networks. The processor can create a second block chain including an indication of the block associated with the NFT. The second block chain can be the reference chain. The indication of the block associated with the NFT can be a pointer to the end-of-life block associated with the NFT, or a copy of the NFT. The second block chain can be stored in an IPFS. A name associated with the second block chain can indicate a location of the block chain among the multiple block chains containing the block associated with the NFT, by using the CAS of the IPFS. The name can be the name of a block containing a pointer to the NFT, or the name of the second block chain. The second block chain can include permissions associated with the NFT. The second block chain can also include the multiple authentication factors.

The processor can establish access to the NFT within the 5G network by authenticating the user request using: 1) asset described, e.g., a unique ID of the NFT, 2) information about the transaction, e.g., ownership change or financial barter, 3) information about the participant(s). For example, the processor can receive a request to enter an operation associated with the NFT. The processor can check whether the request includes a unique ID associated with the NFT and a participant associated with the operation. The processor can check whether the unique ID associated with the NFT is recorded in the block chain. Upon determining that the unique ID associated with the NFT is recorded in the block chain, the processor can retrieve a second entity having an interest in the NFT. The processor can determine whether the participant associated with the operation corresponds to the second entity. Upon determining that the participant associated with the operation corresponds to the second entity, the processor can create a second block in the block chain including the operation associated with the NFT. The entity can be a user, another wireless telecommunication network, a corporation, an artist, a sports team, etc.

The processor can authenticate the user based on the user ID and a UE ID. The processor can receive a request to authenticate the user by receiving a second ID associated with the user and a second ID associated with the UE of the user. The processor can retrieve the ID associated with the user and the ID associated with the UE of the user from the block chain. The processor can determine whether a first match exists by determining whether the second ID associated with the user matches the ID associated with the user stored in the block chain. The processor can determine whether a second match exists by determining whether the second ID associated with the UE matches the ID associated with the UE stored in the block chain. Upon determining that the first match exists and the second match exists, the processor can authenticate the user.

The processor can create a consensus within the block chain using a rumor method, without using proof of work, thereby reducing carbon footprint in creating the consensus. In addition, the processor can create consensus within the block chain using a process of minimum viable consensus methods, which may or may not include Byzantine forms of consensus.

The processor can retrieve the NFT for inspection. If the user has the access to read the end-of-life block, the user can receive either the direct pointer to the archived file or the block on the block chain tracking archived files. No block chain data can be modified or copied once stored in the NFT ledger. The processor can create an end-of-life block in the block chain indicating that the NFT creation is complete. The processor can receive a request from the user to read the end-of-life block. The processor can determine whether the user has a permission to read the end-of-life block. Upon determining that the user has the permission, the processor can send to the user an indication of the end-of-life block in the block chain.

The processor can store the various NFTs and/or block chains described in this application in an IPFS. The processor can make the decision to store the NFTs and/or block chains in an IPFS based on the size of the NFTs and/or the block chain. The processor can obtain a memory footprint associated with each NFT. The processor can determine whether the memory footprint exceeds a predetermined threshold, such as 50 MB. Upon determining that the memory footprint exceeds the predetermined threshold, the processor can store the NFT in an IPFS.

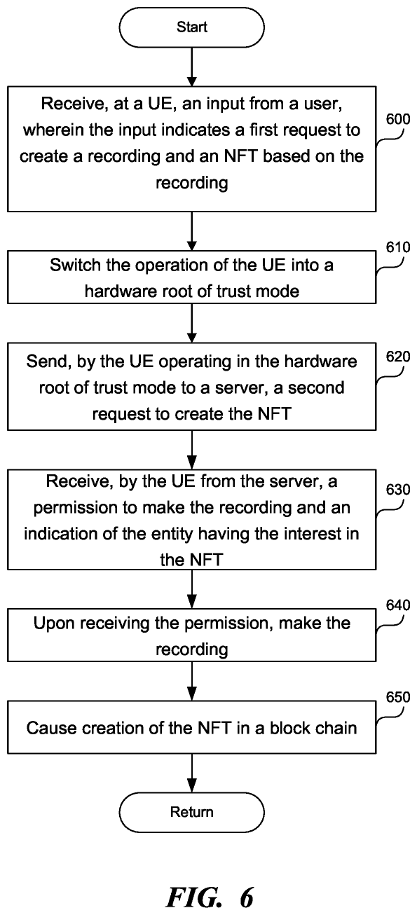

FIG. 6 is a flowchart of a method to securely create an NFT on a block chain using a 5G infrastructure of a wireless telecommunication network, according to another embodiment. The processor, in step 600, can receive, at a UE, an input from a user, where the input indicates a first request to create a recording and an NFT based on the recording. The UE is configured to operate in a rich environment mode, and a hardware root of trust mode, where the rich environment mode does not require cryptographic keys for operation, while the hardware root of trust mode verifies a software running in the hardware root of trust mode using cryptographic keys.

In step 610, the processor can switch the operation of the UE into a hardware root of trust mode. A hardware root of trust is the foundation on which all secure operations of a computing system depend. The hardware root of trust contains the keys used for cryptographic functions and enables a secure boot process. The most secure implementation of a root of trust is in hardware, making it immune from malware attacks. As such, the hardware root of trust can be a stand-alone security module or implemented as a security module within a processor or system-on-chip (SoC).

In step 620, the processor can send, by the UE operating in the hardware root of trust mode to a server, a second request to create the NFT, the request including multiple authentication factors comprising a location associated with the mobile device, a time associated with the request, an identifier (ID) associated with the mobile device, and an ID associated with the user. The processor can send information from other UE sensors such as a microphone, an accelerometer, etc. The server is configured to authenticate the request based on the multiple authentication factors, and upon authenticating the request, determine an entity having an interest in the NFT.

In step 630, the processor can receive, by the UE from the server, a permission to make the recording and an indication of the entity having the interest in the NFT. In step 640, upon receiving the permission, the processor can make the recording. In step 650, the processor can cause creation of the NFT in a block chain.

The processor can receive an input from the user indicating that the recording is complete. The processor can send an indication to the server to create an end-of-life block in the block chain indicating that the NFT creation is complete. The processor can obtain a unique ID associated with the NFT. The processor can store the unique ID at the UE.

### Computer System

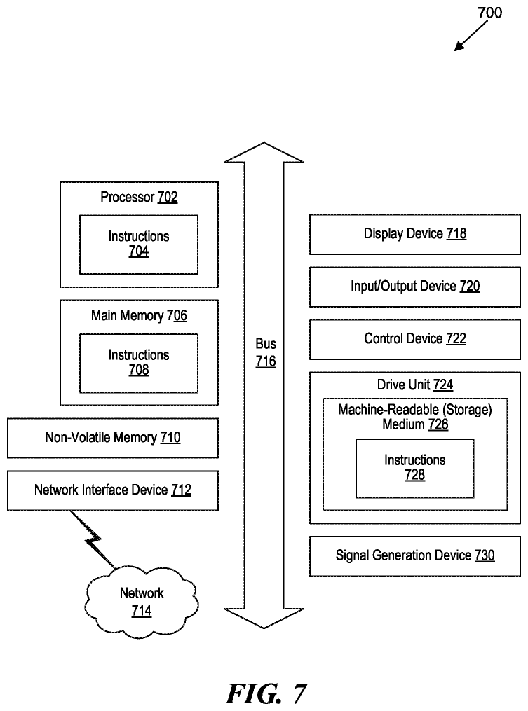

FIG. 7 is a block diagram that illustrates an example of a computer system 700 in which at least some operations described herein can be implemented. As shown, the computer system 700 can include: one or more processors 702, main memory 706, nonvolatile memory 710, a network interface device 712, a video display device 718, an input/output device 720, a control device 722 (e.g., keyboard and pointing device), a drive unit 724 that includes a storage medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the Figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SoC), a single-board computer system (SBC), or a distributed system such as a mesh of computer systems, or it can include one or more cloud components in one or more networks. Where appropriate, one or more computer systems 700 can perform operations in real time, near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, nonvolatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable (storage) medium 726 can include any medium that is capable of storing, encoding, or carrying a set of instructions for execution by the computing system 700. The machine-readable medium 726 can be nontransitory or comprise a nontransitory device. In this context, a nontransitory storage medium can include a device that is tangible, meaning that the device has a concrete physical form, although the device can change its physical state. Thus, for example, nontransitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and nonvolatile memory devices 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/we claim:

1. At least one computer-readable storage medium, excluding transitory signals and carrying instructions to securely create a nonfungible token (NFT) on a block chain using a 5G infrastructure of a wireless telecommunication network, which, when executed by at least one data processor of a system, cause the system to:
receive a request to create an NFT from a mobile device associated with a user,
wherein the request is generated by a software operating on the mobile device in a secure protected boot mode,
wherein the secure protected boot mode ensures integrity of the software using a cryptographic key;
obtain from the software operating on the mobile device multiple authentication factors including a location associated with the mobile device, a time associated with the request, a code indicating an activity occurring at the location at the time, an identifier (ID) associated with the mobile device, and an ID associated with the user,
wherein the software operates in the secure protected boot mode;
based on the multiple authentication factors, determine an entity having an interest in the activity occurring at the location at the time;
search the block chain to determine whether the block chain includes an authorization to record the activity occurring at the location at the time,
wherein the entity grants the authorization,
wherein the authorization is associated with the mobile device;
upon determining that the block chain includes the authorization to record the activity occurring at the location at the time, receive from the software operating on the mobile device a recording associated with the activity occurring at the location at the time,
wherein the recording is obtained by the mobile device; and
upon determining that the block chain includes the authorization to record the activity occurring at the location at the time, create a block chain block including the multiple authentication factors, the authorization to record the activity occurring at the location at the time, and the recording.

2. The computer-readable medium of claim 1, comprising instructions to:
upon determining that the block chain includes the authorization to record the activity occurring at the location at the time, retrieve from the block chain a first indication of interest associated with the entity in the recording and a second indication of interest associated with the user in the recording;
receive an indication of a transfer of funds associated with the recording from a third party to the user; and
distribute the funds to the user and the entity based on the first indication of interest and the second indication of interest.

3. The computer-readable medium of claim 1, comprising instructions to:
upon determining that the block chain includes the authorization to record the activity occurring at the location at the time, retrieve from the block chain a first indication of interest associated with the entity in the recording and a second indication of interest associated with the user in the recording;
distribute information about an auction associated with the NFT to multiple mobile devices,
wherein the information includes an ID associated with the NFT, a time, and a location;
receive multiple bids for the NFT from multiple parties;
determine a highest bid among the multiple bids,
wherein the highest bid is associated with a first party among the multiple parties;
transfer the interest in the NFT to the first party among the multiple parties; and
distribute the highest bid to the entity and the user based on the first indication of interest and the second indication of interest.

4. The computer-readable medium of claim 1, comprising instructions to:
create a unique ID corresponding to the NFT;
obtain multiple block chains;
search the multiple block chains for a block associated with the NFT; and
create a second block chain including an indication of the block associated with the N FT,
wherein a name associated with the second block chain indicates a location of a block chain among the multiple block chains containing the block associated with the NFT,
wherein the second block chain includes permissions associated with the NFT.

5. The computer-readable medium of claim 1, comprising instructions to:
receive a request to enter an operation associated with the NFT;
check whether the request includes a unique ID associated with the NFT and a participant associated with the operation;
check whether the unique ID associated with the NFT is recorded in the block chain;
upon determining that the unique ID associated with the NFT is recorded in the block chain, retrieve a second entity having an interest in the NFT;
determine whether the participant associated with the operation corresponds to the second entity, thereby verifying that the operation associated with the NFT conforms to permissions associated with the NFT and recorded in the block chain; and
upon determining that the participant associated with the operation corresponds to the second entity, create a second block in the block chain including the operation associated with the NFT.

6. The computer-readable medium of claim 1, comprising instructions to:
receive a request to authenticate the user by receiving a second ID associated with the user and a second ID associated with the mobile device of the user;
retrieve the ID associated with the user and the ID associated with the mobile device of the user from the block chain;
determine whether a first match exists by determining whether the second ID associated with the user matches the ID associated with the user stored in the block chain;
determine whether a second match exists by determining whether the second ID associated with the mobile device matches the ID associated with the mobile device stored in the block chain; and
upon determining that the first match exists and the second match exists, authenticate the user.

7. The computer-readable medium of claim 1, comprising instructions to:
create a consensus within the block chain using a process of minimum viable consensus method, without using proof of work, thereby reducing carbon footprint in creating the consensus.

8. The computer-readable medium of claim 1, comprising instructions to:
create an end-of-life block in the block chain indicating that the NFT creation is complete;
receive a request from the user to read the end-of-life block;
determine whether the user has a permission to read the end-of-life block; and
upon determining that the user has the permission, send to the user an indication of the end-of-life block in the block chain.

9. The computer-readable medium of claim 1, comprising instructions to:
obtain a memory footprint associated with the NFT;
determine whether the memory footprint exceeds a predetermined threshold; and
upon determining that the memory footprint exceeds the predetermined threshold, store the NFT in an interplanetary file system.

10. A system comprising:
at least one hardware processor; and
at least one non-transitory memory storing instructions, which, when executed by the at least one hardware processor, cause the system to:
receive a request to create an NFT from a user equipment (UE) associated with a user,
wherein the request is generated by a software operating on the UE in a secure protected boot mode,
wherein the secure protected boot mode ensures integrity of the software using a cryptographic key;
obtain from the software operating on the UE multiple authentication factors including a location associated with the UE, an ID associated with the UE, and an ID associated with the user,
wherein the software operates in the secure protected boot mode;
based on the multiple authentication factors, determine an entity having an interest in an activity occurring at the location at a time;
search a block chain to determine whether the block chain includes an authorization to record the activity occurring at the location at the time,
wherein the entity grants the authorization,
wherein the authorization is associated with the UE;
upon determining that the block chain includes the authorization to record the activity occurring at the location at the time, receive from the software operating on the UE a recording associated with the activity occurring at the location at the time; and
upon determining that the block chain includes the authorization to record the activity occurring at the location at the time, create a block chain block including the multiple authentication factors, the authorization to record the activity occurring at the location at the time, and the recording.

11. The system of claim 10, comprising instructions to:
upon determining that the block chain includes the authorization to record the activity occurring at the location at the time, retrieve from the block chain a first indication of interest associated with the entity in the recording and a second indication of interest associated with the user in the recording;
receive an indication of a transfer of funds associated with the recording from a third party to the user; and
distribute the funds to the user and the entity based on the first indication of interest and the second indication of interest.

12. The system of claim 10, comprising instructions to:
upon determining that the block chain includes the authorization to record the activity occurring at the location at the time, retrieve from the block chain a first indication of interest associated with the entity in the recording and a second indication of interest associated with the user in the recording;
distribute information about an auction associated with the NFT to multiple UEs,
wherein the information includes an ID associated with the NFT, a time, and a location;
receive multiple bids for the NFT from multiple parties;
determine a highest bid among the multiple bids,
wherein the highest bid is associated with a first party among the multiple parties;
transfer the interest in the NFT to the first party among the multiple parties; and
distribute the highest bid to the entity and the user based on the first indication of interest and the second indication of interest.

13. The system of claim 10, comprising instructions to:
create a unique ID corresponding to the NFT;
obtain multiple block chains;
search the multiple block chains for a block associated with the NFT; and
create a second block chain including an indication of the block associated with the NFT,
wherein a name associated with the second block chain indicates a location of a block chain among the multiple block chains containing the block associated with the NFT,
wherein the second block chain includes permissions associated with the NFT and the multiple authentication factors.

14. The system of claim 10, comprising instructions to:
receive a request to enter an operation associated with the NFT;
check whether the request includes a unique ID associated with the NFT and a participant associated with the operation;
check whether the unique ID associated with the NFT is recorded in the block chain;
upon determining that the unique ID associated with the NFT is recorded in the block chain, retrieve a second entity having an interest in the NFT;
determine whether a participant associated with the operation corresponds to the second entity; and
upon determining that the participant associated with the operation corresponds to the second entity, create a second block in the block chain including the operation associated with the NFT.

15. The system of claim 10, comprising instructions to:
receive a request to authenticate the user by receiving a second ID associated with the user and a second ID associated with the UE of the user;
retrieve the ID associated with the user and the ID associated with the UE of the user from the block chain;
determine whether a first match exists by determining whether the second ID associated with the user matches the ID associated with the user stored in the block chain;
determine whether a second match exists by determining whether the second ID associated with the UE matches the ID associated with the UE stored in the block chain; and
upon determining that the first match exists and the second match exists, authenticate the user.

16. The system of claim 10, comprising instructions to:
create a consensus within the block chain using a process of minimum viable consensus method, without using proof of work, thereby reducing carbon footprint in creating the consensus.

17. The system of claim 10, comprising instructions to:
create an end-of-life block in the block chain indicating that the NFT creation is complete;
receive a request from the user to read the end-of-life block;
determine whether the user has a permission to read the end-of-life block; and
upon determining that the user has the permission, send to the user an indication of the end-of-life block in the block chain.

18. The system of claim 10, comprising instructions to:
obtain a memory footprint associated with the NFT;
determine whether the memory footprint exceeds a predetermined threshold; and
upon determining that the memory footprint exceeds the predetermined threshold, store the NFT in an interplanetary file system.

19. A system comprising:
at least one hardware processor; and
at least one non-transitory memory storing instructions, which, when executed by the at least one hardware processor, cause the system to:
receive, at a UE, an input from a user,
wherein the input indicates a first request to create a recording and an NFT based on the recording,
wherein the UE is configured to operate in a rich environment mode, and a hardware root of trust mode,
wherein the rich environment mode does not require cryptographic keys for operation, and
wherein the hardware root of trust mode verifies a software running in the hardware root of trust mode using cryptographic keys;
switch the operation of the UE into a hardware root of trust mode;
send, by the UE operating in the hardware root of trust mode to a server, a second request to create the NFT, the request including multiple authentication factors,
wherein the multiple authentication factors are generated locally at the UE,
wherein the server is configured to authenticate the request based on the multiple authentication factors,
wherein the server is configured to, upon authenticating the request, determine an entity having an interest in the NFT;
receive, by the UE from the server, a permission to make the recording and an indication of the entity having the interest in the NFT;
upon receiving the permission, make the recording; and
cause creation of the NFT in a block chain.

20. The system of claim 19, wherein the multiple authentication factors include at least two of a location associated with the UE, a time associated with the request, an ID associated with the UE, or an ID associated with the user, and wherein the system further comprises instructions to:
receive an input from the user indicating that the recording is complete;
send an indication to the server to create an end-of-life block in the block chain indicating that the NFT creation is complete;
obtain a unique ID associated with the NFT; and
store the unique ID at the UE.
